(19) United States
(12) Patent Application Publication
(10) Pub. No.: US 2026/0295863 A1
(43) Pub. Date: Oct. 1, 2026

(54) ROBOTIC HAND AND FINGER UNIT

(71) Applicant: HONDA MOTOR CO., LTD., Tokyo (JP)

(72) Inventor: Tetsuya ISHIKAWA, Saitama (JP)

(21) Appl. No.: 19/547,010

(22) Filed: Feb. 23, 2026

(30) Foreign Application Priority Data
Mar. 25, 2025 (JP) 2025-050064

(51) Int. Cl. B25J 15/00

(52) U.S. Cl. CPC B25J 15/0009

(57) ABSTRACT

A robotic hand comprises: connecting members arranged in series and interconnected via joints such that each pair of the associated connecting members are rotatably connected to each other at a corresponding one of the joints; one or more rotation mechanisms, each rotation mechanism being provided for a corresponding one of the joints and configured to cause the associated connecting members to rotate relative to each other in response to torque input thereto; and one or more drive devices, each drive device being configured to output torque to a corresponding one of the rotation mechanisms, wherein a shaft is provided between each of the drive devices and a corresponding one of the rotation mechanisms for transmitting the torque output from each drive device to the corresponding rotation mechanism.

### TECHNICAL FIELD

The present invention relates to a robotic hand and a finger unit that forms a finger portion of the robotic hand.

### BACKGROUND ART

Patent Document 1 discloses a robotic hand equipped with a finger portion that is configured and shaped in a way that resembles a human finger. This finger portion includes a plurality of connecting members (components that correspond to bones of each finger of a human) are rotatably connected via link members so that the connecting members can rotate in conjunction with each other.

### PRIOR ART DOCUMENTS

### Patent Documents

Patent Document 1: JP2013-154409A

### SUMMARY OF THE INVENTION

### TASK TO BE ACCOMPLISHED BY THE INVENTION

In some cases, a robotic hand may be desirably configured to enable joint motions (flexing or extending motion) of joints independently in order to achieve finger movements in a way that resembles or enhanced finger movements compared to those of a human finger. In the robotic hand disclosed in Patent Document 1, the connecting members rotate in conjunction with each other, which makes it difficult to configure the robotic hand to enable each of the joints to be independently driven.

The present invention has been made in view of this need in the prior art, and a primary object of the present invention is to provide a robotic hand configured to enable each of the joints to be independently driven and a finger unit that forms a finger portion of the robotic hand.

### MEANS TO ACCOMPLISH THE TASK

As a solution to the above-described task to be accomplished, an aspect of the present invention provides a robotic hand comprising: connecting members arranged in series and interconnected via joints such that each pair of the associated connecting members are rotatably connected to each other at a corresponding one of the joints; one or more rotation mechanisms, each rotation mechanism being provided for a corresponding one of the joints and enabling relative rotation of the associated connecting members in response to torque input thereto; and one or more drive devices, each drive device being configured to output torque to a corresponding one of the rotation mechanisms, wherein a shaft is provided between each of the drive devices and a corresponding one of the rotation mechanisms for transmitting the torque output from the each drive device to the corresponding rotation mechanism.

As a solution to the above-described task to be accomplished, another aspect of the present invention provides a finger unit comprising: connecting members arranged in series and interconnected via joints such that each pair of the associated connecting members are rotatably connected to each other at a corresponding one of the joints; one or more rotation mechanisms, each rotation mechanism being provided for a corresponding one of the joints and enabling relative rotation of the associated connecting members in response to torque input thereto; and one or more drive devices, each drive device being configured to output torque to a corresponding one of the rotation mechanisms, wherein a flexible shaft is provided between each of the drive devices and a corresponding one of the rotation mechanisms for transmitting the torque output from the each drive device to the corresponding rotation mechanism, wherein one of the connecting members positioned at a base end side of the finger unit forms a connection part that connects to a palm portion; and wherein the connecting members other than the one forming the palm portion, form finger portions connected to the palm portion via the connection part.

### EFFECT OF THE INVENTION

As described above, the present invention makes it possible to provide a robotic hand configured to enable each of the joints to be independently driven and a finger unit that forms a finger portion of the robotic hand.

### BRIEF DESCRIPTION OF THE DRAWINGS

FIG. 1 is a diagram showing a robotic hand according to a first embodiment of the present invention;

FIG. 2 is a diagram showing a rotation mechanism according to a first variant of the embodiment;

FIG. 3 is a diagram showing a rotation mechanism according to a second variant of the embodiment;

FIG. 4 is a diagram showing a robotic hand equipped with a shaft according to a variant of the embodiment;

FIG. 5 is a diagram showing a robotic hand according to a second embodiment of the present invention;

FIG. 6 is a diagram showing a robotic hand according to a first variant of the second embodiment; and

FIG. 7 is a diagram showing a robotic hand according to a second variant of the second embodiment.

### DESCRIPTION OF THE PREFERRED EMBODIMENTS

Embodiments of a robotic hand, and a finger unit that forms a finger portion of the robotic hand according to the present invention will be described with reference to the appended drawings.

### First Embodiment

A robotic hand 1 according to the present invention is what is called a multi-joint robot, and in the present embodiment, the robotic hand 1 is a human-type robot (humanoid robot) that forms a human hand from the palm to a fingertip of the hand.

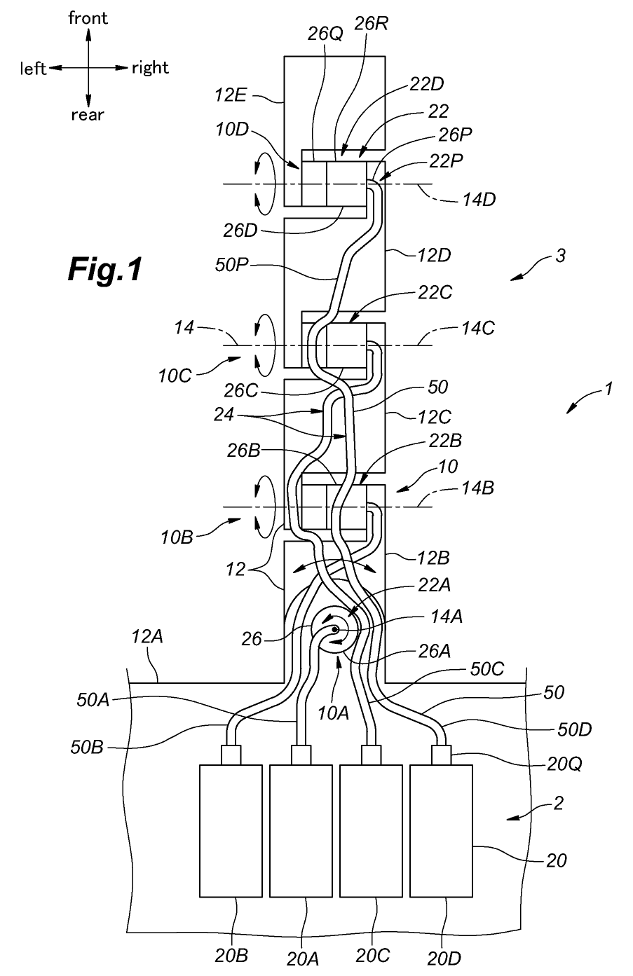

FIG. 1 shows a schematic diagram of a configuration of the robotic hand 1 according to a first embodiment of the present invention. However, FIG. 1 shows only an exemplary configuration, and embodiments of the present invention are not limited thereto.

The robotic hand 1 comprises a palm portion 2 corresponding to a human palm and at least one finger portion 3 connected to the palm portion 2 at its base. The finger portion 3 is configured to flex and extend freely in a similar manner to a human finger. Although FIG. 1 shows only one finger portion 3 enlarged, in the present embodiment, four additional finger portions 3 are similarly connected to the palm portion 2 like a human hand. The structure of the other four finger portions 3 is generally the same as that of the finger portion 3 shown in FIG. 1; therefore, the description of them will not be repeated. FIG. 1 also shows that the finger portion 3 is in a state where it is extended (extended state).

For the sake of convenience in the following description, directions are defined relative to the finger portion 3 in its extended state as shown in FIG. 1; that is, the directions toward the free end and base end of the finger portion 3 are defined as the front and rear directions, respectively, and the directions toward which two main surfaces of the palm portion 2 face are defines as the up and down directions. It should be noted that expressions indicating these directions are used herein for the sake of convenience in the description, but not for the purpose of limiting the directions in embodiments of the present invention.

The robotic hand 1 includes three or more connecting members 12 arranged in series and interconnected via joint 10. Each pair of the associated connecting members 12 are rotatably connected to each other at a corresponding one of the joints 10, enabling their relative rotation around the joint axis 14 of the corresponding joint 10.

The robotic hand 1 shown in FIG. 1 includes, in order from the base end thereof, a first connecting member 12A, a second connecting member 12B, a third connecting member 12C, a fourth connecting member 12D, and a fifth connecting member 12E, as the connecting members 12.

The first connecting member 12A forms the palm portion 2. The first connecting member 12A has a substantially flat plate shape, similar to a human palm.

The second connecting member 12B is rod-shaped. The second connecting member 12B is connected at its base end to the first connecting member 12A via the joint 10 (hereinafter referred to as the first joint 10A). The second connecting member 12B is connected to the first connecting member 12A at the first joint 10A, allowing rotation around its joint axis 14 (hereinafter referred to as the first joint axis 14A) extending in the up-down direction (see Arrows in FIG. 1).

The third connecting member 12C is rod-shaped. The third connecting member 12C is connected at its base end to the free end of the second connecting member 12B via the joint 10 (hereinafter referred to as the second joint 10B). The third connecting member 12C is connected to the second connecting member 12B at the second joint 10B, allowing rotation around its joint axis 14 (hereinafter referred to as the second joint axis 14B) extending in the left-right direction (see Arrows in FIG. 1).

The fourth connecting member 12D is rod-shaped. The fourth connecting member 12D is connected at its base end to the free end of the third connecting member 12C via the joint 10 (hereinafter referred to as the third joint 10C). The fourth connecting member 12D is connected to the third connecting member 12C at the third joint 10C, allowing rotation around its joint axis 14 (hereinafter referred to as the third joint axis 14C) extending in the left-right direction (see Arrows in FIG. 1).

The fifth connecting member 12E is rod-shaped. The fifth connecting member 12E is connected at its base end to the free end of the fourth connecting member 12D via the joint 10 (hereinafter referred to as the fourth joint 10D). The fifth connecting member 12E is connected to the fourth connecting member 12D at the fourth joint 10D, allowing rotation around its joint axis 14 (hereinafter referred to as the fourth joint axis 14D) extending in the left-right direction (see Arrows in FIG. 1).

The finger portion 3 with a plurality of joints 10 is formed by the second connecting member 12B, the third connecting member 12C, the fourth connecting member 12D, and the fifth connecting member 12E.

The robotic hand 1 includes drive devices 20, rotation mechanisms 22, and transmission mechanisms 24. For each joint 10 (i.e., for each joint axis 14), the corresponding drive device 20, rotation mechanism 22, and transmission mechanism 24 are provided.

For each joint 10, a corresponding one of the drive devices 20 is provided and outputs torque to an output shaft 20Q. The torque output to the output shaft 20Q is used to rotate the associated connecting members 12, connected via the corresponding joint 10, around its joint axis 14. In the present embodiment, each of the drive devices 20 is configured by an electric motor.

As shown in FIG. 1, the robotic hand 1 includes a first drive device 20A, a second drive device 20B, a third drive device 20C, and a fourth drive device 20D, as the drive devices 20.

The first drive device 20A outputs torque to rotate the second connecting member 12B relative to the first connecting member 12A around the first joint axis 14A.

The second drive device 20B outputs torque to rotate the third connecting member 12C relative to the second connecting member 12B around the second joint axis 14B.

The third drive device 20C outputs torque to rotate the fourth connecting member 12D relative to the third connecting member 12C around the third joint axis 14C.

The fourth drive device 20D outputs torque to rotate the fifth connecting member 12E relative to the fourth connecting member 12D around the fourth joint axis 14D.

The torque output from the first drive device 20A causes the finger portion 3 to rotate around the first joint axis 14A at its base end, moving its free end in the left-right direction. The torque output from the second drive device 20B causes the finger portion 3 to rotate around the second joint axis 14B at its base end, moving its free end in the up-down direction.

The torque output from the third drive device 20C causes the finger portion 3 to flex and extend at the third joint 10C. The torque output from the third drive device 20C causes the finger portion 3 to flex and extend at the fourth joint 10D.

As shown in FIG. 1, in the present embodiment, the drive devices 20 (the first drive device 20A, second drive device 20B, third drive device 20C, and fourth drive device 20D) are arranged in a planar array on the first connecting member 12A (i.e., palm portion 2) and are each secured to the first connecting member 12A. Thus, each of the drive devices 20 is supported by the first connecting member 12A.

For each joint 10 (i.e., for each joint axis 14), a corresponding one of the rotation mechanisms 22 is provided to rotate the associated two connecting members 12, which are connected via the corresponding joint 10, around the corresponding joint axis 14 in response to torque input to the input shaft 22P.

The robotic hand 1 includes a first rotation mechanism 22A, a second rotation mechanism 22B, a third rotation mechanism 22C, and a fourth rotation mechanism 22D, as the rotation mechanisms 22.

The first rotation mechanism 22A rotates the second connecting member 12B relative to the first connecting member 12A around the first joint axis 14A in response to the input torque.

The second rotation mechanism 22B rotates the third connecting member 12C relative to the second connecting member 12B around the second joint axis 14B in response to the input torque.

The third rotation mechanism 22C rotates the fourth connecting member 12D relative to the third connecting member 12C around the third joint axis 14C in response to the input torque.

The fourth rotation mechanism 22D rotates the fifth connecting member 12E relative to the fourth connecting member 12D around the fourth joint axis 14D in response to the input torque.

For each joint, the rotation mechanism 22 may be provided between the two connecting members 12, or it may be provided at a position away from a connection part (i.e., joint 10) of the associated two connecting members 12.

In the present embodiment, each of the rotation mechanisms 22 includes a reducer 26 disposed along the corresponding joint axis 14. The reducer 26 is positioned between the connecting members 12 to be connected at the corresponding joint 10 so as to rotatably connect the two connecting members 12 to each other.

Each reducer 26 includes an input shaft 26P, an output shaft 26Q, and a housing 26R. The input shaft 26P and the output shaft 26Q are rotatably supported by the housing 26R, and the reducer 26 reduces the speed of rotation input to the input shaft 26P to output high torque to the output shaft 26Q. The reducer 26 may be configured by, for example, a planetary gear mechanism, a cycloidal gear mechanism, or a harmonic drive (Registered Trademark). The input shaft 26P of each reducer 26 forms the input shaft 22P of the corresponding rotation mechanism 22.

In the present embodiment, each reducer 26 is configured by a coaxial reducer in which the input shaft 26P and the output shaft 26Q are arranged on the same axis. The housing 26R of the reducer 26 is fixed to one connecting member 12, and the other connecting member 12 is fixed to the output shaft 26Q. As a result, the connecting members 12 are rotatably connected to each other.

When torque is input to the input shaft 26P of the reducer 26, causing rotation of the input shaft 26P of the reducer 26, the torque is output to the output shaft 26Q of the reducer 26, causing the two connecting members 12 to rotate relative to each other around the joint axis 14.

In the present embodiment, the robotic hand 1 includes a first reducer 26A positioned along the first joint axis 14A, a second reducer 26B positioned along the second joint axis 14B, a third reducer 26C positioned along the third joint axis 14C, and a fourth reducer 26D positioned along the fourth joint axis 14D, as the reducers 26.

The first reducer 26A is positioned between the first connecting member 12A and the second connecting member 12B, forming part of the first joint 10A. The housing 26R of the first reducer 26A is fixed to the first connecting member 12A, and the output shaft 26Q is fixed to the second connecting member 12B. When torque is applied to the input shaft 26P of the first reducer 26A, the second connecting member 12B rotates relative to the first connecting member 12A around the first joint axis 14A.

The second reducer 26B is positioned between the second connecting member 12B and the third connecting member 12C, forming part of the second joint 10B. The housing 26R of the second reducer 26B is fixed to the second connecting member 12B, and the output shaft 26Q is fixed to the third connecting member 12C. When torque is applied to the input shaft 26P of the second reducer 26B, the third connecting member 12C rotates relative to the second connecting member 12B around the second joint axis 14B.

The third reducer 26C is positioned between the third connecting member 12C and the fourth connecting member 12D, forming part of the third joint 10C. The housing 26R of the third reducer 26C is fixed to the third connecting member 12C, and the output shaft 26Q is fixed to the fourth connecting member 12D. When torque is applied to the input shaft 26P of the third reducer 26C, the fourth connecting member 12D rotates relative to the third connecting member 12C around the third joint axis 14C.

The fourth reducer 26D is positioned between the fourth connecting member 12D and the fifth connecting member 12E, forming part of the fourth joint 10D. The housing 26R of the fourth reducer 26D is fixed to the fourth connecting member 12D, and the output shaft 26Q is fixed to the fifth connecting member 12E. When torque is applied to the input shaft 26P of the fourth reducer 26D, the fifth connecting member 12E rotates relative to the fourth connecting member 12D around the third joint axis 14C.

In some cases, the reducer 26 forming the rotation mechanism 22 does not need to be provided along the joint axis 14. The reducer 26 may be provided at a position separated from the joint axis 14. In such a case, an additional mechanism is provided to use the output of the reducer 26 to cause relative rotation of the two connecting members 12, which are connected to each other to be rotatable around the corresponding joint axis 14.

For example, the rotation mechanism 22 may be configured to include a reducer 26 positioned away from the corresponding joint axis 14 (joint 10), and a link mechanism 30 that uses the output of the reducer 26 to rotate the connecting member 12.

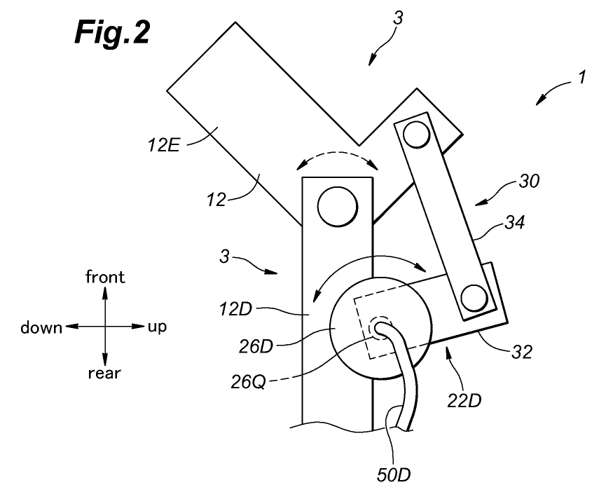

FIG. 2 shows an embodiment in which the fourth rotation mechanism 22D includes the fourth reducer 26D positioned away from the fourth joint axis 14D (fourth joint 10D), the link mechanism 30 that uses the output of the fourth reducer 26D to cause the fourth connecting member 12D and the fifth connecting member 12E to rotate relative to each other. FIG. 2 shows the free end portion of the finger portion 3 in a side view (as viewed from the left-right direction).

In the embodiment shown in FIG. 2, the fourth reducer 26D is fixed within its housing 26R at a position spaced apart from the fourth joint axis 14D of the fourth connecting member 12D.

The link mechanism 30 includes a first link 32 fixed to the output shaft 26Q of the fourth reducer 26D, and a second link 34 rotatably connected to both the first link 32 and the fifth connecting member 12E.

When torque is input to the input shaft 26P of the fourth reducer 26D, causing rotation of the output shaft 26Q of the fourth reducer 26D, the rotation of the output shaft 26Q causes the first link 32 to rotate (see Solid Arrows in FIG. 2).

As the first link 32 and the fifth connecting member 12E are connected by the second link 34, the rotation of the first link 32 causes the fifth connecting member 12E to rotate (see Dashed Arrows in FIG. 2), causing the finger portion 3 to flex and extend at the fourth joint 10D.

In this way, as the reducer 26 is positioned away from the joint axis 14, a region where the corresponding joint 10 is provided can be made small.

The rotation mechanism 22 is not necessarily configured by the reducer 26. The rotation mechanism 22 may have any configuration which allows the associated two connecting members 12 to rotate relative to each other in response to the input torque.

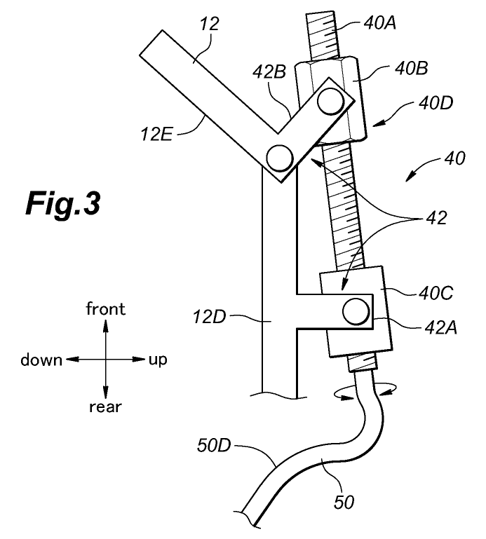

FIG. 3 shows an embodiment in which the fourth rotation mechanism 22D does not include the reducer 26. FIG. 3 shows the free end portion of the finger portion 3 in a side view in the same manner as that shown in FIG. 2.

In the embodiment shown in FIG. 3, the fourth rotation mechanism 22D is positioned away from the fourth joint 10D, and includes a conversion mechanism 40 that converts the input torque into linear motion, and a rotational drive mechanism 42 that uses the output of the conversion mechanism 40 to rotate the fifth connecting member 12E relative to the fourth connecting member 12D.

The conversion mechanism 40 is configured by what is called a ball screw mechanism 40D, including a screw shaft 40A, a nut 40B connected to the screw shaft 40A, rolling balls (not shown) positioned between the screw shaft 40A and the nut 40B, and a housing 40C that supports the screw shaft 40A via a bearing. When torque is applied to one end of the screw shaft 40A, the nut 40B slides along the longitudinal direction of the screw shaft 40A, which converts the torque applied to the screw shaft 40A into linear motion of the nut 40B.

The rotational drive mechanism 42 includes a housing connection portion 42A integrally provided on the fourth connecting member 12D and a nut connection portion 42B integrally provided on the fifth connecting member 12E.

The housing connection portion 42A is rotatably connected to the housing 40C of the conversion mechanism 40, enabling their relative rotation around an axis extending in the left-right direction. Thus, the conversion mechanism 40 with its screw shaft 40A extending toward the fifth connecting member 12E, is rotatably supported by the fourth connecting member 12D, enabling their relative rotation around an axis extending in the left-right direction.

The nut connection portion 42B forms part of the fifth connecting member 12E and is rotatably connected to the nut 40B, enabling their relative rotation around an axis extending in the left-right direction.

When torque is input to one end of the screw shaft 40A and the nut 40B moves to be close to the fifth connecting member 12E, the fifth connecting member 12E rotates counterclockwise relative to the fourth connecting member 12D, causing the fourth joint 10D to flex.

When torque is input to one end of the screw shaft 40A and the nut 40B moves away from the fifth connecting member 12E, the fifth connecting member 12E rotates counterclockwise relative to the fourth connecting member 12D, causing the fourth joint 10D to flex.

In this way, when the reducer 26 is positioned away from the joint axis 14, a region where the corresponding joint 10 is provided can be made small.

The transmission mechanism 24 is provided for each joint axis 14 and transmits the torque output from the corresponding drive device 20 to the corresponding rotation mechanism 22.

The transmission mechanism 24 includes a shaft 50 that connects the output shaft 20Q of the drive device 20 to the input shaft 22P of the rotation mechanism 22 (e.g., the input shaft 26P of the reducer 26 in FIG. 2). When the output shaft 20Q of the drive device 20 rotates, the shaft 50 rotates and transmits torque to the input shaft 22P of the rotation mechanism 22, causing the associated two connecting members 12 to rotate relative to each other around the corresponding joint axis 14.

In the embodiment shown in FIG. 1, the robotic hand 1 includes: as the shafts 50, a first shaft 50A connecting the output shaft 20Q of the first drive device 20A and the input shaft 26P of the first reducer 26A; a second shaft 50B connecting the output shaft 20Q of the second drive device 20B and the input shaft 26P of the second reducer 26B; a third shaft 50C connecting the output shaft 20Q of the third drive device 20C and the input shaft 26P of the third reducer 26C ; and a fourth shaft 50D connecting the output shaft 20Q of the fourth drive device 20D and the input shaft 26P of the fourth reducer 26D.

In the embodiment shown in FIG. 1, each of the shafts 50 is formed of a flexible shaft 50P that is made flexible. However, the form of shafts is not limited to this configuration, and any form of the shaft is possible provided that at least a portion of a shaft 50 is formed by the flexible shaft 50P. In this case, the remaining portion of the shaft 50 may be formed by one or more straight shafts 50Q (highly-rigid straight shaft), which have higher rigidity (specifically, torsional rigidity) than the flexible shaft 50P.

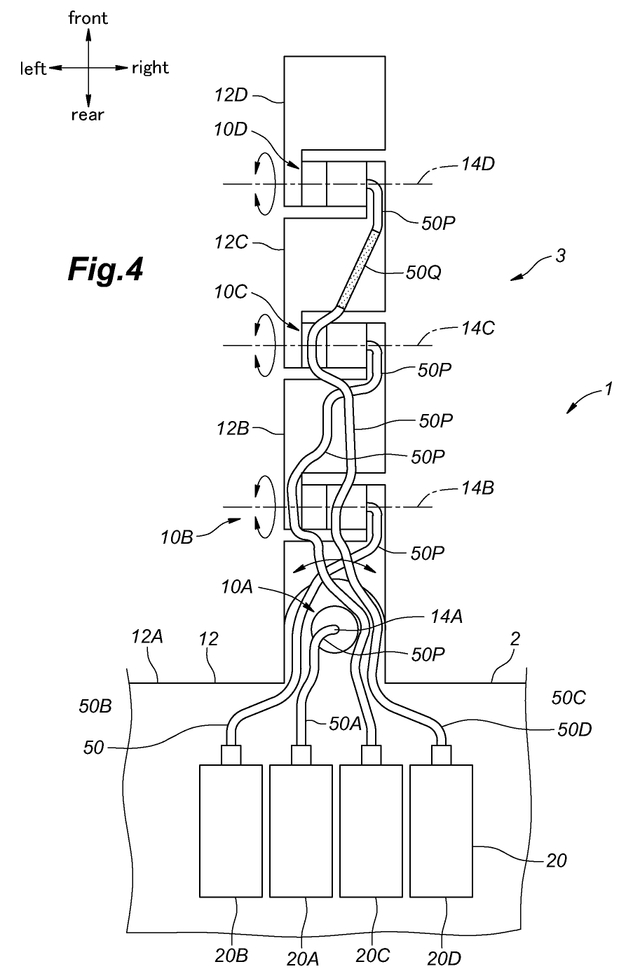

FIG. 4 shows an embodiment in which one shaft 50 (fourth shaft 50D) is, in part, formed by the straight shaft 50Q. In FIG. 4, the portions of the shaft 50 without shadow (without dot hatching) indicate parts formed by flexible shafts 50P, while the portion with shadow (with dot hatching) indicates a part formed by the straight shaft 50Q. Preferably, as shown in FIG. 4, the straight shaft 50Q forms a portion of the shaft 50 other than the part thereof that passes over a joint 10.

The straight shaft 50Q is formed of a linear member that forms a straight line, while each of the flexible shafts 50P is more flexible than the straight shaft 50Q and capable of bending deformation. The straight shaft 50Q may be formed, for example, of a metal rod-shaped member, while the flexible shafts 50P may be each formed of a metal wire-shaped member that is more easily deformed (less rigid) than the material of the straight shaft 50Q.

Any of the flexible shafts 50P may be produced by arranging several strands composed of steel rod (wire) or any other suitable wire rod in a strip-like manner on a single bendable core wire (core rod), and winding them in a direction forming a predetermined pitch angle relative to the axis to form a first winding layer, and then repeating the similar process, i.e., arranging several strands in a strip-like manner and winding them in the opposite direction to the previous layer to thereby form subsequent winding layers (i.e., second and third winding layers).

In other cases, each of the flexible shafts 50P may be composed primarily of a plurality of link members that are arranged along a single longitudinal axis of a finger portion and rotatably connected to each other. Each of the link members may be configured as a rod-shaped member or as a tubular member (e.g., a cylindrical member).

Although, in the embodiment shown in FIG. 1, the single finger portion 3 is provided on the palm portion 2, the palm portion 2 may also have two or more finger portions 3. This configures the robotic hand to be a robotic hand 1 with multiple fingers (multi-finger robotic hand). In this case as well, a connecting member 12 forming the palm portion 2 and a plurality of connecting members 12 forming each finger portion 3 are arranged in series and connected to each other in a rotatable manner via the joints 10. Furthermore, in this case as well, the drive devices 20 are preferably arranged in a planar array and fixed to the palm portion 2.

Next, the effect achieved by the so-configured robotic hand 1 will be described.

As shown in FIG. 1, a rotation mechanism 22, a shaft 50, and a drive device 20 are provided for each of the joints 10 in the robotic hand. This enables each of the joints 10 to be independently driven by independently controlling the corresponding one of the drive devices 20. Thus, this configuration can provide a robotic hand 1 configured to enable each of the joints 10 to be independently driven.

The torque output by each drive device 20 is transmitted to a corresponding one of the rotation mechanisms 22 via a shaft 50. This means that no link mechanism is required to transmit power from the drive device 20 to the joint 10 in the robotic hand 1, which reduces the number of parts and thus the manufacturing cost of the robotic hand 1.

In the above embodiment, the shaft 50 is formed, at least in part, by the flexible shaft 50P having flexibility. Thus, by using the flexible shaft 50P where flexibility is required, the shaft 50 can be deformed to conform to the motion of the driven robotic hand 1.

In some embodiments, the rotation mechanism 22 may be configured by a reducer 26. In this case, use of a reducer 26 with a high reduction ratio enables the drive device 20 (i.e., the electric motor) to be made compact, thereby enabling the first connecting member 12A (i.e., the palm portion 2) to be made smaller. Use of a reducer 26 with a high reduction ratio also enables the generation of a large fingertip force at the tip of the finger portion 3. Moreover, use of a reducer 26 with reduced backlash can prevent the occurrence of backlash of the mechanism during the movement of the finger portion 3.

Furthermore, the drive devices 20 are positioned on the palm portion 2, which means that, even when an upper arm is connected to the palm portion 2 via a joint 10, there is no need to provide any transmission mechanism 24 that passes over the joint 10 (wrist joint), which can prevent the transmission mechanism 24 from hindering the movement of the wrist joint 10 between the palm portion 2 and the upper arm.

### Second Embodiment

A robotic hand 1 according to a second embodiment of the present invention is different from that of the first embodiment in that the first connecting member 12A forms a part of the palm portion 2 and is connected to a palm main body 60, which forms a main part of the palm portion 2. The other features are substantially the same as those of the first embodiment, and the description of such features will not be repeated here

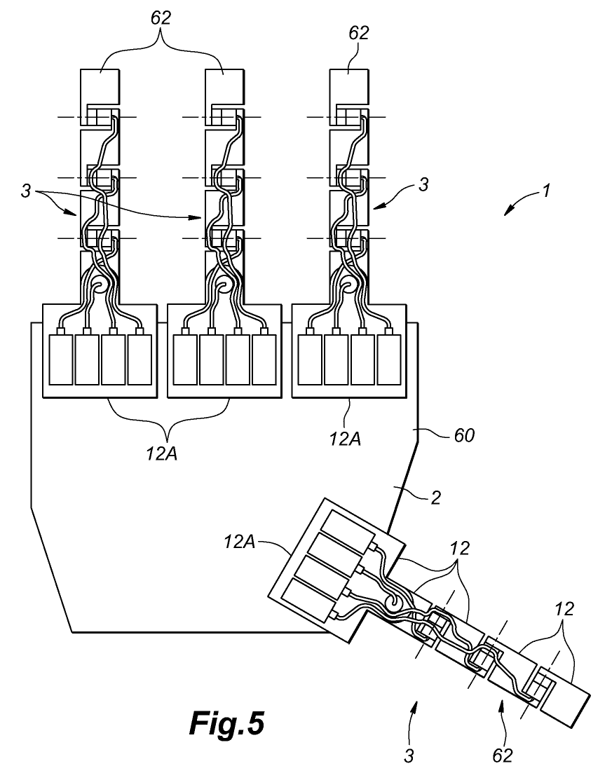

As shown in FIG. 5, the robotic hand 1 includes finger units 62, each of which forms a finger portion thereof and includes: the connecting members 12 (first connecting member 12A, second connecting member 12B, third connecting member 12C, fourth connecting member 12D, fifth connecting member 12E) arranged in series and rotatably connected to each other via the joints 10; the rotation mechanism 22; the drive devices 20; and the shafts 50. As in the first embodiment, for each joint 10, a corresponding one of the rotation mechanisms 22 is provided. Similar to the first embodiment, the first connecting member 12A is one positioned at the base end, among the connecting members 12 arranged in series. The drive device 20 is arranged in a planar array on the first connecting member 12A and is fixed thereto. The first connecting member 12A is configured to be connectable to the palm main body 60, and forms part of the palm portion 2 in cooperation with the palm main body 60.

A robotic hand 1 with multiple fingers (multi-finger robotic hand) is configured by multiple finger units 62 connected to the palm main body 60.

FIG. 5 shows that the palm main body 60 is configured to have a generally similar shape to a human palm. Similar to a human hand, the finger units 62 are connected at positions corresponding to the bases of the thumb, index finger, middle finger, and ring finger of the palm main body 60.

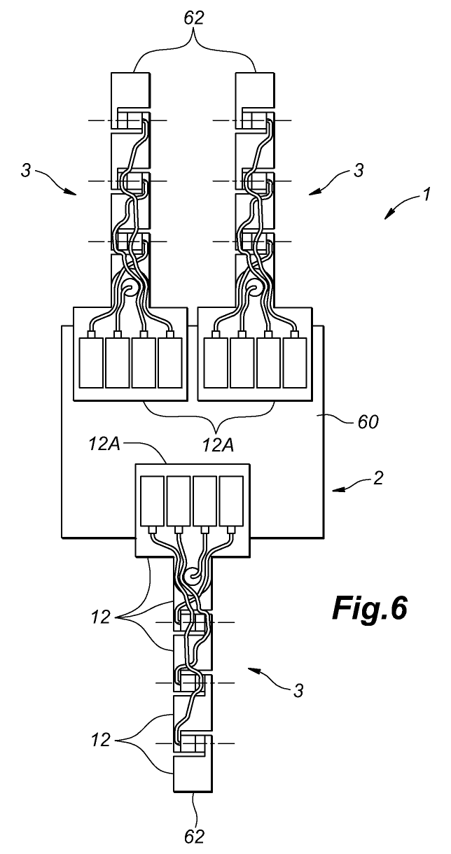

FIG. 6 shows an embodiment in which finger units 62 are connected to the palm main body 60 to form the robotic hand 1 in a similar manner to the embodiment shown in FIG. 5. In FIG. 6, the palm main body 60 is configured to form a substantially rectangular plate having a pair of long sides and a pair of short sides, and two finger units 62 are attached to one long edge side of the palm main body 60, and one finger unit 62 is attached to the other long edge side.

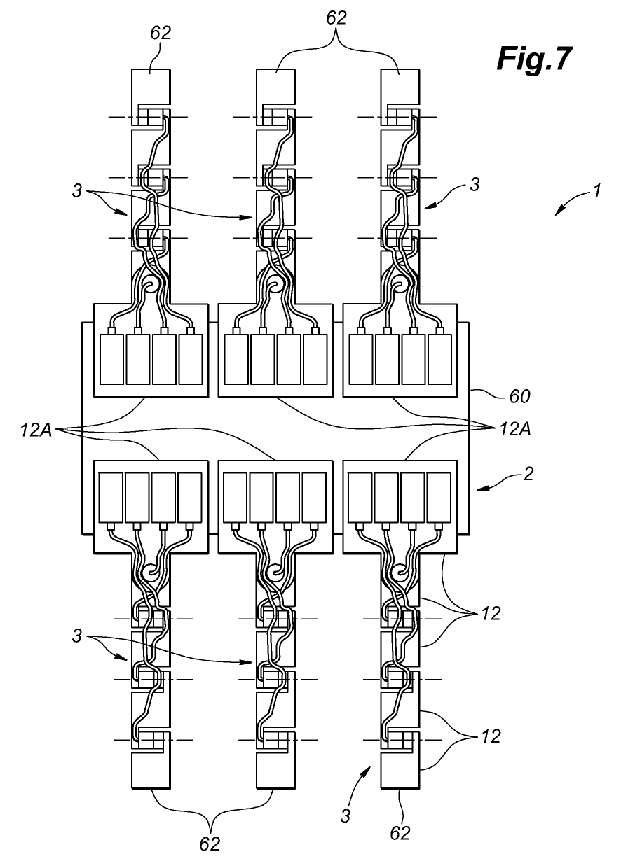

FIG. 7 shows an embodiment in which finger units 62 are connected to the palm main body 60 to form the robotic hand 1 in a similar manner to the embodiments shown in FIGS. 5 and 6. Similarly to the embodiment in FIG. 6, the palm main body 60 in FIG. 7 is configured to form a substantially rectangular plate having a pair of long sides and a pair of short sides, , and two finger units 62 are attached to one long edge side of the palm main body 60, and one finger unit 62 is attached to the other long edge side.

In this way, use of unitized or modular finger portions 3 enables the robotic hand 1 to be configured in a wide variety of forms. For example, the number and positions of finger units 62 can be determined according to the size, shape, weight, and intended use of an object to be grasped by the robotic hand. Furthermore, adopting unitized or modular finger portions 3 can reduce the manufacturing costs and simplify the manufacturing process. Moreover, this enables replacement of the finger units 62 for maintenance, improving the maintainability of the robotic hand 1.

The present invention has been described in terms of specific embodiments, but is not limited by such embodiments, and can be embodied with various modifications. Various changes may be made to features of the embodiments such as specific configuration, position, and quantity of each component or element thereof without departing from the scope of the present invention. Moreover, part or all features of the different embodiments may be combined with each other to yield another embodiment. In the above-described embodiments, not all elements included therein are essential, and some of them may be eliminated or replaced as appropriate.

For example, in the embodiment shown in FIG. 1, the reducer 26 is provided at each joint 10. However, for each joint 10, a torque sensor may also be provided in addition to the reducer 26. Adopting the torque sensor enables joint torque control.

The configurations of the robotic hand 1 are not limited to these forms in which a plurality of finger portions 3 are provided on the robotic hand 1, and any form in which at least one finger portion 3 is provided is possible. For example, the robotic hand 1 may be provided with only one finger portion 3 having a welding end effector positioned at its tip, which allows the robotic hand 1 to be configured as part of a welding robot. In this way, a robotic hand 1 according to the present invention may also be formed as an end effector for performing various tasks. In addition, a robotic hand 1 for grasping objects may be configured by a combination of a finger portion 3 (finger unit 62) described in the above embodiment and a finger portion 3 incapable of flexing.

In FIGS. 1 and 5, the shafts 50 extend along the upper surface of the robotic hand 1 and are configured to be exposed on the outer surface of the robotic hand 1. However, the configuration of the robotic hand 1 is not limited to such embodiments. For example, each of the connecting members 12 may be configured as a tubular hollow shape or a groove-shaped channel, and the shafts 50 may be placed to pass through the interior of the connecting members 12, thereby preventing the shafts 50 from being exposed on the outer surface of the robotic hand 1. This configuration enables the shafts 50 to be less likely to hinder the upward rotation of the third connecting member 12C, fourth connecting member 12D, and fifth connecting member 12E. This means that the range of motion of the finger portion 3 can be expanded. Furthermore, this configuration eliminates the need to consider the orientation of a finger unit 62 during assembly work to assemble it onto the palm main body 60, improving the efficiency of the work of assembling the finger unit 62.

In the above-described embodiments, the drive devices 20 are provided on the palm portion 2. However, the drive devices 20 may also be provided on components other than the palm portion 2, such as the connecting members 12 or components forming a forearm.

Although, in the above-described embodiments, the drive devices 20 are arranged in a planar array on the palm portion 2, the arrangement of drive devices 20 is not limited to this. For example, the third drive device 20C may be provided on the top of the first drive device 20A, and the fourth drive device 20D may be provided on top of the second drive device 20B. The fourth drive device 20D may be provided on top of the first drive device 20A, and the third drive device 20C may be provided on top of the second drive device 20B.

Although, in the above-described embodiments, each reducer 26 is provided at a corresponding joint 10, the reducer 26 may be coupled to the corresponding drive device 20 such that the output of the reducer 26 is transmitted to the corresponding joint 10 via the shaft 50. Furthermore, the reducer 26 is not essential; that is, the output of each drive device 20 may be transmitted directly to the corresponding joint 10 via the shaft 50.

The robotic hand 1 of the present invention, which is applied not only to industrial robots for grasping objects, can be applied to surgical robots, multi-finger form devices with tactile feedback, and any other suitable devices as well.

### Summary of Embodiments

The above-described embodiments of the present invention are summarized as follows.

One aspect of the present invention provides a robotic hand 1 comprising: connecting members 12 arranged in series and interconnected via joints 10 such that each pair of the associated connecting members 12 are rotatably connected to each other at a corresponding one of the joints 10; rotation mechanisms 22, each rotation mechanism 22 being provided for a corresponding one of the joints 10 and enabling relative rotation of the associated connecting members 12 in response to torque input thereto; and drive devices 20, each drive device 20 being configured to output torque to a corresponding one of the rotation mechanisms 22, wherein a shaft 50 is provided between each of the drive devices 20 and a corresponding one of the rotation mechanisms 22 for transmitting the torque output from the each drive device 20 to the corresponding rotation mechanism 22.

This configuration, in which the rotation mechanism 22, the shaft 50, and the drive device 20 are provided for each of the joints 10 in the robotic hand, can provide the robotic hand 1 configured to enable each of the joints 10 to be independently driven.

Preferably, the above robotic hand is further configured such that the shaft 50 is formed, at least in part, by a flexible shaft 50P having flexibility.

In this configuration, a part of the shaft 50 where flexibility is required, can be made flexible.

Preferably, the above robotic hand is further configured such that one of the connecting members 12 positioned at a base end side of the robotic hand forms a palm portion 2, and wherein the connecting members 12 other than the one forming the palm portion 2, form finger portions 3 connected to the palm portion b.

In this case, the robotic hand 1 can be configured to include the palm portion 2 and the finger portions 3.

Preferably, the above robotic hand is further configured such that two or more of the finger portions 3 are connected to the palm portion 2.

In this configuration, the robotic hand 1 can be configured to include a plurality of finger portions 3.

Preferably, the above robotic hand is further configured such that the drive devices 20 are arranged in a planar manner on the palm portion 2.

This configuration enables the robotic hand 1 to be made compact.

Preferably, the above robotic hand is further configured such that each of the rotation mechanisms 22 includes a reducer 26 that connects the associated connecting members 12 to each other for their relative rotation, and wherein the shaft 50 for the each rotation mechanism connects the drive device 20 to the reducer 26.

This configuration enables each of the joints 10 to be independently driven with a simple structure.

Preferably, the above robotic hand is further configured such that each of the rotation mechanisms 22 comprises a reducer 26 at a position separated from the associated joint 10; and a link mechanism 30 that rotates the associated connecting members 12 based on an output of the reducer 26, wherein one of the shafts 50 connects the corresponding drive device 20 to the reducer 26.

This configuration enables each of the joints 10 to be independently driven and enables the reducer 26 to be positioned away from the corresponding joint 10.

Preferably, the above robotic hand is further configured such that each of the rotation mechanisms 22 comprises a conversion mechanism 40 that converts input torque into a linear motion; and a rotational drive mechanism 42 that rotates the associated connecting members 12 based on an output of the conversion mechanism 40, wherein one of the shafts 50 connects the corresponding drive device 20 and the conversion mechanism 40.

In this configuration, the rotation mechanism 22 can be configured by using the conversion mechanism 40 that converts input torque into a linear motion.

Another aspect of the present invention provides a finger unit 62 comprising: connecting members 12 arranged in series and interconnected via joints 10 such that each pair of the associated connecting members 12 a re rotatably connected to each other at a corresponding one of the joints 10; rotation mechanisms 22, each rotation mechanism 22 being provided for a corresponding one of the joints 10 and enabling relative rotation of the associated connecting members 12 in response to torque input thereto; and drive devices 20, each drive device 20 being configured to output torque to a corresponding one of the rotation mechanisms 22, wherein a shaft 50 is provided between each of the drive devices 20 and a corresponding one of the rotation mechanisms 22 for transmitting the torque output from the each drive device 20 to the corresponding rotation mechanism 22, and wherein the connecting member 12 positioned at a base end side of the finger unit is configured to be connectable to a palm main body 60, which forms a palm main part of a palm portion 2.

This configuration, in which the rotation mechanism 22, the shaft 50, and the drive device 20 are provided for each of the joints 10 in the finger unit, can provide the finger unit 62 configured to enable each of the joints 10 to be independently driven.

1. A robotic hand comprising:
connecting members arranged in series and interconnected via joints such that each pair of the associated connecting members are rotatably connected to each other at a corresponding one of the joints;
one or more rotation mechanisms, each rotation mechanism being provided for a corresponding one of the joints and enabling relative rotation of the associated connecting members in response to torque input thereto; and
one or more drive devices, each drive device being configured to output torque to a corresponding one of the rotation mechanisms,
wherein a shaft is provided between each of the drive devices and a corresponding one of the rotation mechanisms for transmitting the torque output from the each drive device to the corresponding rotation mechanism.

2. The robotic hand as claimed in claim 1, wherein the shaft is formed, at least in part, by a flexible shaft having flexibility.

3. The robotic hand as claimed in claim 2, wherein one of the connecting members positioned at a base end side of the robotic hand forms a palm portion, and
wherein the connecting members other than the one forming the palm portion, form finger portions connected to the palm portion.

4. The robotic hand as claimed in claim 3, wherein two or more of the finger portions are connected to the palm portion.

5. The robotic hand as claimed in claim 3, wherein the drive devices are arranged in a planar manner on the palm portion.

6. The robotic hand as claimed in claim 1, wherein each of the rotation mechanisms includes a reducer that connects the associated connecting members to each other for their relative rotation, and
wherein the shaft for the each rotation mechanism connects the drive device to the reducer.

7. The robotic hand as claimed in claim 1, wherein each of the rotation mechanisms comprises a reducer at a position separated from the associated joint; and a link mechanism that rotates the associated connecting members based on an output of the reducer,
wherein one of the shafts connects the corresponding drive device to the reducer.

8. The robotic hand as claimed in claim 1, wherein each of the rotation mechanisms comprises a conversion mechanism that converts input torque into a linear motion; and a rotational drive mechanism that rotates the associated connecting members based on an output of the conversion mechanism,
wherein one of the shafts connects the corresponding drive device and the conversion mechanism.

9. A finger unit comprising:
connecting members arranged in series and interconnected via joints such that each pair of the associated connecting members are rotatably connected to each other at a corresponding one of the joints;
one or more rotation mechanisms, each rotation mechanism being provided for a corresponding one of the joints and enabling relative rotation of the associated connecting members in response to torque input thereto; and
one or more drive devices, each drive device being configured to output torque to a corresponding one of the rotation mechanisms,
wherein a shaft is provided between each of the drive devices and a corresponding one of the rotation mechanisms for transmitting the torque output from the each drive device to the corresponding rotation mechanism, and
wherein the connecting member positioned at a base end side of the finger unit is configured to be connectable to a palm main body, which forms a palm main part of a palm portion.
